(19) United States
(12) Patent Application Publication
(10) Pub. No.: US 2007/0093944 A1
(43) Pub. Date: Apr. 26, 2007

(54) Tactile device and method using sequential actuation

(76) Inventor: Hugh T. Lee, Derry, NH (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/545,887

(22) Filed: Oct. 11, 2006

Related U.S. Application Data
(60) Provisional application No. 60/728,716, filed on Oct. 20, 2005.

(51) Int. Cl. G01C 23/00

(52) U.S. Cl. 701/3

(57) ABSTRACT

A tactile device for an aircraft operator has a plurality of sequentially-actuated tactors connected to an aircraft operator, the plurality of tactors including a first tactor and a second tactor neighboring the first tactor. A control system controls actuation of the tactors as a function of a variable representing a characteristic of the operation of the aircraft.

### BACKGROUND

The present invention relates to a tactile device and method for providing information to an aircraft, motor vehicle or equipment operator.

Devices and methods for providing information tactually to aircraft operators are known.

U.S. Pat. No. 2,078,982, hereby incorporated by reference herein, for example, describes a tactile device for registering airspeed, altitude or a turn indicator. The information is provided tactually via the operator grasping the tactile device, and is not provided passively.

U.S. Pat. No. 3,902,687, also hereby incorporated by reference herein, describes an aircraft indicator system having a seat cushion and a leg clamp with left and right vibrators which indicate to the aircraft operator a deviation from a course selected via a radio navigational aid receiver. A frequency of vibration is indicative of the magnitude of the deviation.

The United States Navy at http://www.namrl.navy.mil/TSAS/, the entire description of which is also hereby incorporated by reference herein, describes a tactile situation awareness system (TSAS) which provides aircraft operators with a vest with tactors arranged in a grid fashion. The tactors provide pitch and roll information via absolute actuating of the tactors. In other words, to convey information regarding pitch, only one tactor at a time is actuated.

### BRIEF SUMMARY OF THE INVENTION

Commonly-owned U.S. patent application Ser. No. 10/844,726 relates also to providing tactile information.

An object of the present invention is to improve the ability to convey information tactually to aircraft operators. An alternate or additional object of the present invention is to improve the ability to convey information tactually to motor vehicle or equipment operators.

The present invention provides a tactile device for an aircraft operator which has a plurality of tactors contacting an aircraft operator, the plurality of tactors including a first tactor and a second tactor neighboring the first tactor. A control system controls actuation of the tactors as a function of a variable representing a characteristic of the operation of the aircraft and actuates the first tactor and the second tactor sequentially when the variable reaches a first predetermined value.

By providing for actuation of both the first and second tactors as the variable reaches a certain value and actuation of any subsequent adjacent tactors as the variable reaches other predetermined values, the operator obtains a relative moving sensation caused by the first tactor and the second tactor. This moving sequential sensation may be easily felt. Since pilots are used to landing lights for an aircraft which sequentially guide a pilot, the sequential sensation also may provide a familiar guide or feel for a pilot. Advantageously, less powerful tactors or more closely spaced tactors may be provided to convey the information from the variable.

The tactors preferably are connected passively to the aircraft operator.

By having the tactors passively attached to the operator, as opposed to on a handle or at the seat where the position of the operator with regard to the tactors may change, the tactors also may convey information more effectively.

The tactile device may include a third tactor, the second tactor being located between the first and third tactors, the first, second and third tactors all being actuated sequentially when the variable reaches the first predetermined value, or as the variable reaches a series of predetermined values. Thus for example if the characteristic is altitude, as the altitude drops to a first level, the first, second and third tactors may be actuated sequentially to indicate to the pilot that the aircraft is losing altitude. Alternately, the tactors could be actuated sequentially to provide an instruction for corrective action, for example if the aircraft is losing altitude, the sequential action could indicate to the pilot to “pull-up” or increase altitude.

Advantageously, the speed of the sequential actuation may be altered as the characteristic varies further, so that for example if the altitude drops to 5000 meters, all of the tactors are actuated sequentially within a 3 second period, and if the altitude drops to 3000 meters, the tactors are actuated within a 2 second period. A sense of urgency related to the speed of the sequential movement thus may be achieved.

The first, second and third tactors may be arranged linearly, and may be spaced equidistantly.

The characteristic may for example be one of altitude or airspeed. The characteristic also could be the proximity of the aircraft in relation to a threat, for example a surface-to-air missile or another nearby aircraft or topographic feature. The characteristic also could be direction, for example with tactors on a left arm being actuated sequentially to indicate that the aircraft is turning left or should be turned to the left, and tactors on a right arm being actuated sequentially to indicate that the aircraft is turning right or should be turned to the right. The speed of the sequential movement can indicate the degree of the turn.

The tactors for example may be spaced within two centimeters of each other, or more preferably within one centimeter or less of another. Since a forearm, which is an advantageous location for the tactors of the present invention, typically provides about 20 centimeters of tactile space, up to twenty or more tactors may be able to be provided on the forearm. Each individual tactor may be 1.0 cm or less in length and width, and even less than 0.5 cm in length and width. Small piezoelectric tactors for example may advantageously be used with the present invention.

Preferably, the tactors are supported by a longitudinal strip of material, which may be fastened for example via perpendicular VELCRO or adhesive tape strips to the forearm. This permits easier attachment of a plurality of tactors. The tactors also may be fastened by a longitudinal strip of adhesive tape or by other means.

The present invention also provides a method for actuating a plurality of tactors connected to an aircraft operator, the plurality of tactors including a first tactor and a second tactor neighboring the first tactor. The method includes actuating a first tactor and then a second tactor sequentially when a variable reaches a first predetermined value, the variable being a function of a variable representing a characteristic of the operation of the aircraft.

Any of the tactile devices according to the present invention above may also be provided for a motor vehicle or equipment operator to provide information regarding a motor vehicle or other equipment operating characteristic.

Sequentially as defined herein means that the average sensation of the actuation of the second tactor is after the average sensation provided by the actuation of the first tactor, although the overall sensation provided by each may overlap in time.

The tactors need not be arranged linearly, but can be arranged in a variety of patterns, with sequential actuation of the tactors in a variety of patterns to convey various kinds of information, such a weapons “lock-on” target.

### BRIEF DESCRIPTION OF THE DRAWINGS

Various embodiments of the present invention are described with respect to the figures in which:

FIG. 1 shows a tactile device having a plurality of tactors for attachment to a forearm of an aircraft, motor vehicle or equipment operator; and

FIG. 2 shows an alternate tactile device in circular form.

### DETAILED DESCRIPTION

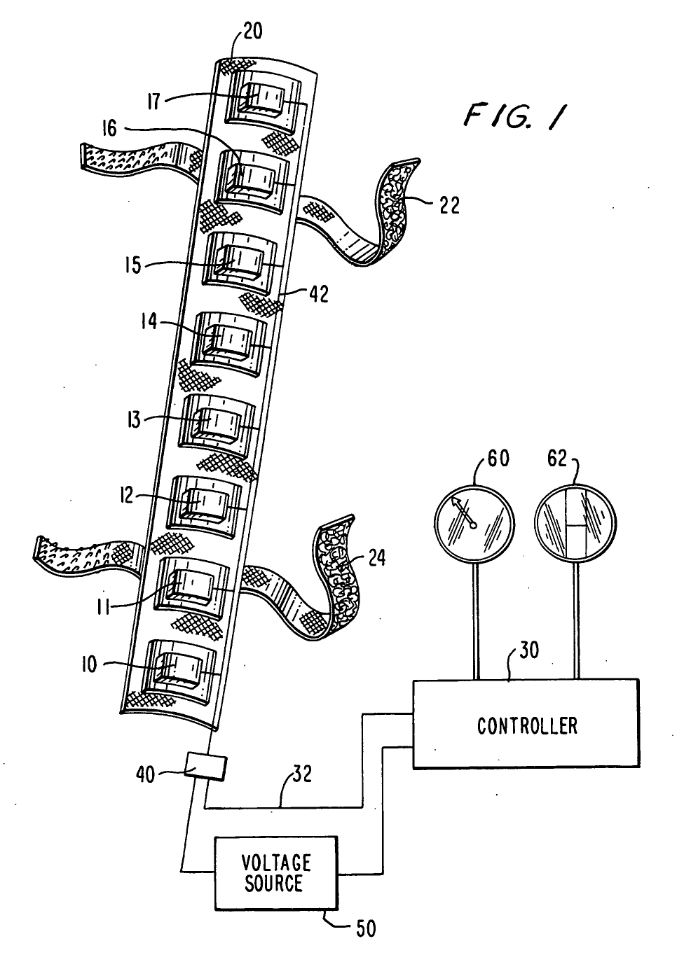

FIG. 1 shows a tactile device having a plurality of tactors for attachment to a forearm of an aircraft, motor vehicle or equipment operator. A plurality of tactors 11, 12, 13, 14, 15, 16 and 17 may be arranged linearly and may be spaced at equal distances on a longitudinal strip of material 20, which can be attached via VELCRO or adhesive tape strips 22, 24 for example to the forearm of an aircraft operator. Preferably, the tactors directly contact the skin of the operator. The strip of material 20 or tactors 11 may for example be about 0.5 inches wide. The strip of material preferably is made of cloth or other flexible natural or synthetic material.

The tactors may be piezoelectric or pneumatic tactors for example, or may be vibrating motors, for example those manufactured by ALCOM or JAMECO, or may be tactors which provide heat or a minor electric charge to the skin. The tactors may contact the skin directly through cutouts in the strip 20, or if appropriate through the strip 20. A lubricant or gel may be used to increase electric sensitivity to the charge.

A voltage source 50 may provide electricity to the tactors through a flexible connection 40. A battery source alternately could be located directly on the strip 20.

A controller 30 may receive inputs from an airspeed detector 60 and/or an altimeter 62, and/or other components of the aircraft or of a motor vehicle or other equipment.

As a function of theses inputs, controller 30 controls individual actuation of the tactors via connection 40 and a flexible control line 32. Each tactor may be connected to a bus 42 and has an individually addressable location for a header for control signals from the controller 30. For example, with eight tactor system shown, a three bit header can be used, as well as a single bit on/off control signal. The connections between the controller 30 and tactors and aircraft operating signal inputs may be wireless. Each tactor may also be connected via an individual wire or other connection to the controller 30, instead of through the bus 42.

As an example with aircraft speed, when the aircraft is at zero speed, the tactors 10 to 17 may be non-actuated. As the aircraft increases in speed, for example to 100 miles per hour, tactors 10, 11, 12, 13, 14, 15, 16, and 17 are actuated sequentially. For example within an 8 second period, so that tactor 10 is actuated at t=one second after the 100 mile speed is reached, tactor 11 actuated at t=two seconds etc., to indicate that this speed has been reached. When tactor 11 is actuated, tactor 10 preferably may be deactivated, however it also may remain activated. When tactor 17 is activated at t=eight seconds, the entire tactor set may be deactivated and the sequence from tactor 10 to 17 repeated.

When the aircraft reaches 200 miles per hour, the sequence may be increased in speed, so that for example the tactors 10 to 17 are activated with a seven second period. The sequence may be repeated as long as the aircraft has not reached another threshold. At 300 miles per hour, the tactors 10 to 17 may be actuated within a six second period, and so on until at 700 miles per hour the tactors 10 to 17 are actuated with a two second period. As the aircraft slows the sequence also may slow.

The speed of the sequential actuation may vary with the aircraft variable, or in stepwise fashion, or inverse fashion for example. For example in the above example between 200 and 300 miles per hour the speed of the actuation may increase linearly, or the speed may remain at eight actuations per eight seconds until the aircraft speed of 300 miles per hour is reached.

The tactile device thus provides a sensitive tactile device for airspeed, which can aid in reducing or eliminating the need for the aircraft operator to view the airspeed indicator. The present invention has particular applicability to military aircraft where the pilots often face visual and aural information overload.

A second strip with tactors could be provided for the other arm for indicating altitude, and controlled by controller 30 in a similar manner as the altitude varies.

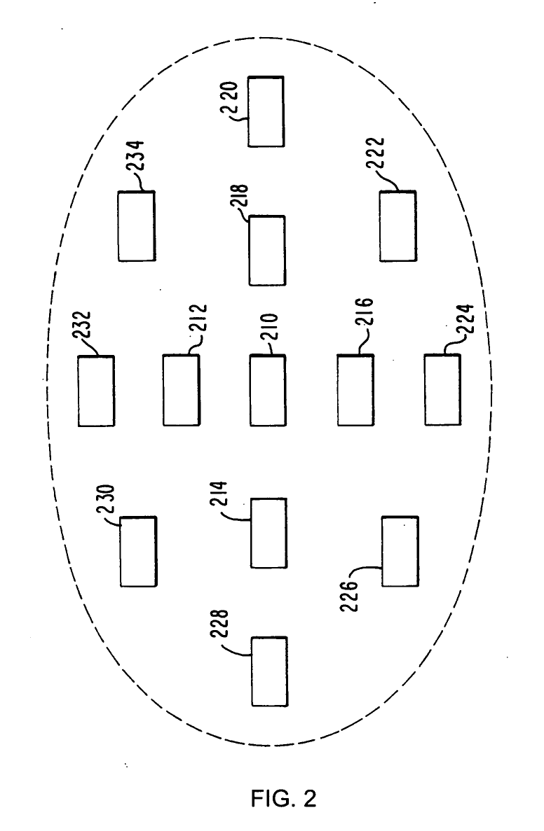

FIG. 2 shows an alternate embodiment in which tactors 210, 212, 214, 216, 218, 220, 222, 222, 224, 226, 228, 230 and 232 are arranged in a circular or expanding or contracting pattern, and could be used for example to indicate aircraft direction or target “lock-on”. Thus for example when the aircraft speed is heading due north tactors 210, 212 and 232 could be actuated sequentially, while when travelling WNW tactors 210 and 230 could be actuated sequentially, and when travelling west tactors 210, 214 and 228 could be actuated sequentially. For target “lock-on” the pattern could for example be a sequential activation toward the center of the circular pattern, representing a bulls-eye of a target.

The embodiments of FIGS. 1 and 2 could also be used for example to provide motor vehicle or equipment operating information, for example vehicle speed information or proximity information, for example the proximity of a crane to an object.

The first predetermined value may be zero.

What is claimed is:

1. A tactile device for an aircraft operator comprising:
a plurality of tactors connected to an aircraft operator, the plurality of tactors including a first tactor and a second tactor neighboring the first tactor; and
a control system controlling actuation of the tactors as a function of a variable representing a characteristic of the operation of the aircraft, the control system actuating the first tactor and the second tactor sequentially when the variable reaches a first predetermined value.

2. The tactile device as recited in claim 1 wherein the plurality of tactors further includes a third tactor, the second tactor being located between the first and third tactors, the first, second and third tactors all being actuated sequentially when the variable reaches the first or subsequent predetermined value.

3. The tactile device as recited in claim 2 wherein the first, second and third tactors are arranged linearly.

4. The tactile device as recited in claim 2 wherein the first and second tactors and second and third tactors are spaced at equal distances.

5. The tactile device as recited in claim 1 wherein a speed of the sequential actuation varies as a function of the characteristic.

6. The tactile device as recited in claim 1 wherein the characteristic is one of altitude or airspeed.

7. The tactile device as recited in claim 1 wherein the first and second tactors are spaced within two centimeters of each other.

8. The tactile device as recited in claim 2 wherein the first and second tactors, and second and third tactors are spaced within two centimeters of each other.

9. The tactile device as recited in claim 1 further comprising a third tactor and a longitudinal strip of material, the first, second and third tactors being supported by the strip.

10. The tactile device as recited in claim 9 further comprising a VELCRO attachment or adhesive tape to attach the longitudinal strip of material to the operator.

11. The tactile device as recited in claim 1 wherein the device attaches to a forearm.

12. The tactile device as recited in claim 1 wherein the plurality of tactors are arranged in a linearly-laterally or circular expanding or contracting pattern.

13. The tactile device as recited in claim 12 wherein the sequential activation direction indicates an aircraft direction.

14. The tactile device as recited in claim 12 wherein the sequential activation direction indicates target location.

15. The tactile device as recited in claim 1 wherein each of the plurality of tactors is a separate attachable strip.

16. The tactile device as recited in claim 1 wherein the plurality of tactors is passively attached to the aircraft operator.

17. A method for actuating a plurality of tactors connected to an aircraft operator, the plurality of tactors including a first tactor and a second tactor neighboring the first tactor, the method comprising:
actuating a first tactor and a second tactor sequentially when a variable reaches a first predetermined value.

18. A tactile device for a motor vehicle or equipment operator comprising:
a plurality of tactors connected to the motor vehicle or equipment operator, the plurality of tactors including a first tactor and a second tactor neighboring the first tactor; and
a control system controlling actuation of the tactors as a function of a variable representing a characteristic of the operation of the motor vehicle or equipment, the control system actuating the first tactor and the second tactor sequentially when the variable reaches a first predetermined value.
